(19) United States
(12) Patent Application Publication
(10) Pub. No.: US 2018/0050748 A1
(43) Pub. Date: Feb. 22, 2018

(54) Bicycle Training System

(71) Applicant: Thomas Faust, Pittsburg, TX (US)

(72) Inventor: Thomas Faust, Pittsburg, TX (US)

(21) Appl. No.: 15/239,179

(22) Filed: Aug. 17, 2016

(51) Int. Cl. B62H 7/00

(52) U.S. Cl. CPC B62H 7/00

(57) ABSTRACT

A bicycle training system for bicycle training includes a bicycle that has a rear tire and a seat post. A yoke is provided and the yoke is removably coupled to the bicycle. The yoke may be gripped by a first user. Thus, the first user stabilizes the bicycle when a second user is learning to ride the bicycle.

### BACKGROUND OF THE DISCLOSURE

### Field of the Disclosure

The disclosure relates to training devices and more particularly pertains to a new training device for bicycle training.

### SUMMARY OF THE DISCLOSURE

An embodiment of the disclosure meets the needs presented above by generally comprising a bicycle that has a rear tire and a seat post. A yoke is provided and the yoke is removably coupled to the bicycle. The yoke may be gripped by a first user. Thus, the first user stabilizes the bicycle when a second user is learning to ride the bicycle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a bicycle training system according to an embodiment of the disclosure.

FIG. 2 is a front view of an embodiment of the disclosure.

FIG. 3 is a right side view of an embodiment of the disclosure.

FIG. 4 is a top view of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

### DESCRIPTION OF THE PREFERRED EMBODIMENT

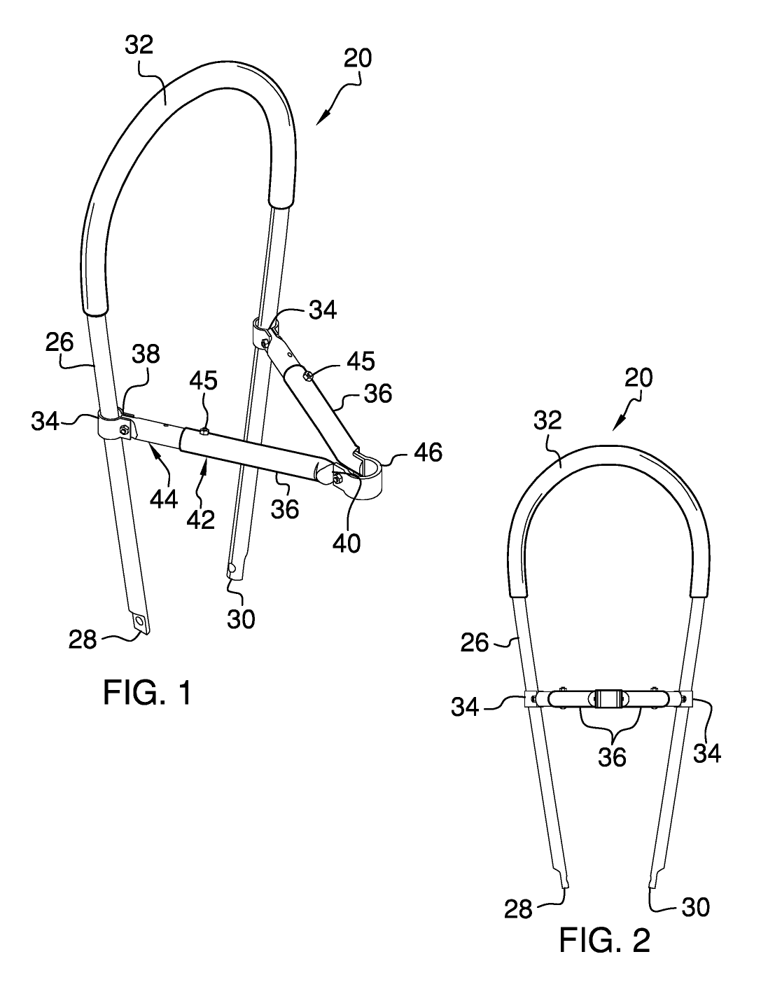

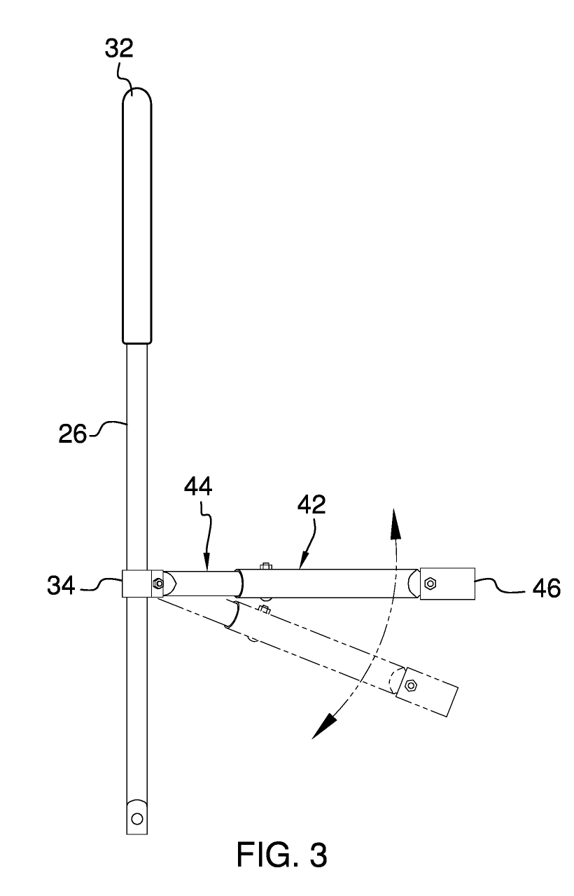

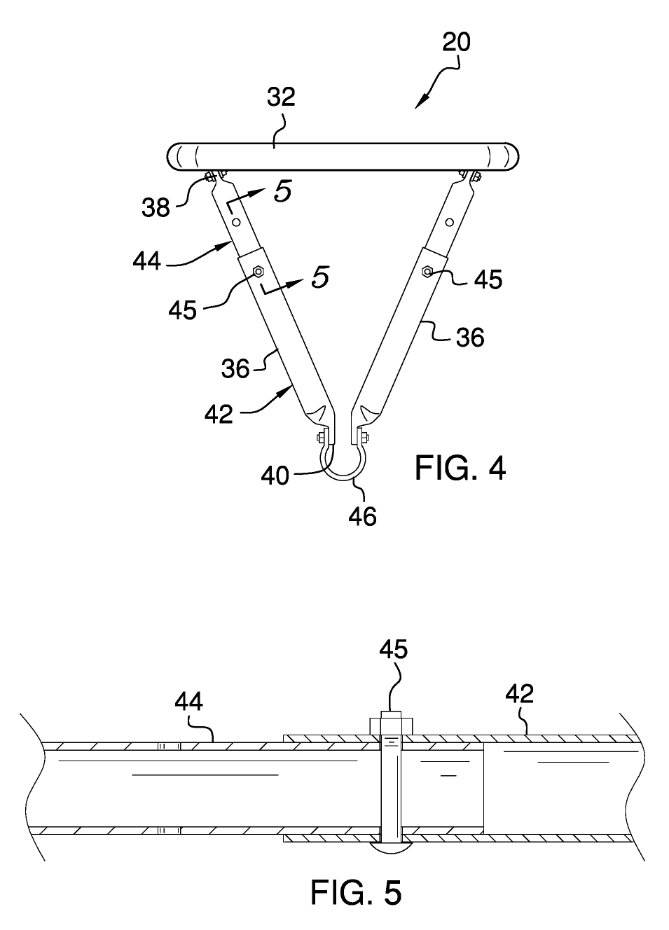

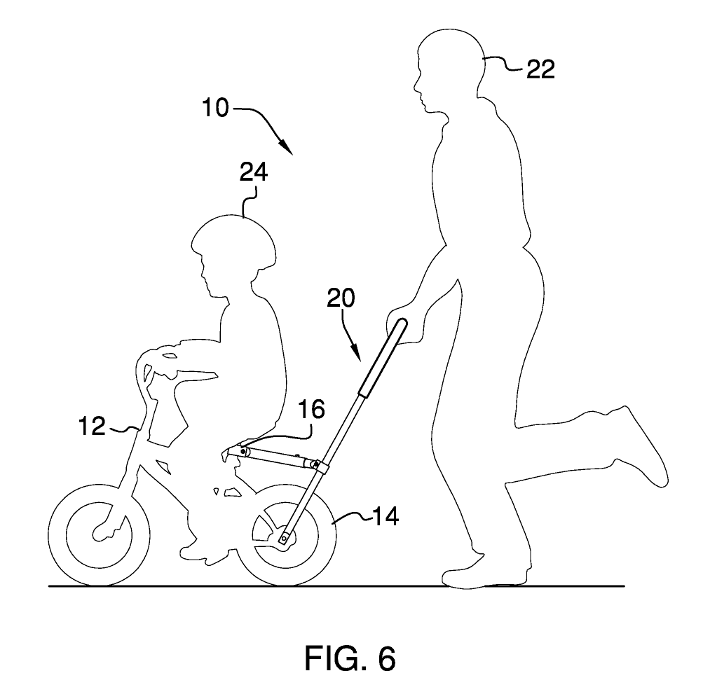

With reference now to the drawings, and in particular to FIGS. 1 through 6 thereof, a new training device embodying the principles and concepts of an embodiment of the disclosure and generally designated by the reference numeral 10 will be described.

As best illustrated in FIGS. 1 through 6, the bicycle training system 10 generally comprises a bicycle 12 that has a rear tire 14 and a seat post 16. The rear tire 14 has an axle 18. The bicycle 12 may be a child's bicycle 12. Moreover, the bicycle 12 may be ridden by a child when the child is learning to ride a bicycle 12.

A yoke 20 is provided and the yoke 20 is removably coupled to the bicycle 12. The yoke 20 is gripped by a first user 22. Thus, the first user 22 stabilizes the bicycle 12 when a second user 24 is learning to ride the bicycle 12. The second user 24 may be an adult and the second user 24 may be the child.

The yoke 20 comprises a handle 26 that has a first end 28 and a second end 30. The handle 26 is curved and the first end 28 is spaced from the second end 30. Each of the first end 28 and the second end 30 is coupled to the axle 18 on the bicycle 12. Thus, the handle 26 extends upwardly from the rear tire 14.

A grip 32 is provided. The grip 32 is coupled to the handle 26. The grip 32 enhances gripping the handle 26. The grip 32 is centrally positioned between the first end 28 and the second end 30. The grip 32 may be comprised of a resiliently compressible material.

A pair of first couplers 34 is provided. Each of the first couplers 34 is coupled to the handle 26. Each of the first couplers 34 may a clamp or the like that extends around the handle 26. Each of the first couplers 34 may be tightened to frictionally engage the handle 26.

A pair of braces 36 is provided. Each of the braces 36 has a primary end 38 and a secondary end 40. Each of the braces 36 comprises a first half 42 that is slidably coupled to a second half 44. Thus, each of the braces 36 has a telescopically adjustable length.

Each of the braces 36 may include a fastener 45. The fastener 45 may extend through the first half 42 and engage the second half 44. Thus, each of the braces 36 is retained at a selected length. The primary end 38 of each of the braces 36 is coupled to an associated one of the first couplers 34. The fastener 45 may comprise a nut and bolt or the like.

A second coupler 46 is provided. The second coupler 46 is coupled to the secondary end 40 of each of the braces 36. Thus, the braces 36 form a V. The second coupler 46 is removably coupled to the seat post 16. Each of the braces 36 extends between the seat post 16 and the handle 26. Thus, the handle 26 is retained in a substantially vertical orientation. The second coupler 46 may comprise a clamp or the like. Moreover, the second coupler 46 may be tightened around the seat post 16.

In use, the handle 26 is coupled to the axle 18. The second coupler 46 is coupled to the seat post 16. Each of the braces 36 is coupled to the second coupler 46. Each of the braces 36 is positioned at a selected length. The second user 24 grips the grip 32 when the first user 22 is learning to ride the bicycle 12. Thus, the bicycle 12 is stabilized and inhibited from tipping over. The handle 26 and the second coupler 46 are removed from the bicycle 12 when the first user 22 learns to ride the bicycle 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A bicycle training system comprising:
a bicycle having a rear tire and a seat post, said rear tire having an axle; and
a yoke being removably coupled to said bicycle wherein said yoke is configured to be gripped by a first user thereby facilitating the first user to stabilize said bicycle when a second user is learning to ride said bicycle, said yoke comprising a handle having a first end and a second end, said handle being curved within a plane such that said handle is planar and said first end is spaced from said second end, each of said first end and said second end being coupled to said axle on said bicycle having said handle extending upwardly from said rear tire such that said handle is coplanar with an axis of rotation of said rear tire whereby said handle is configured to be grasped in alignment with the axis of rotation of said rear tire.

2. (canceled)

3. The system according to claim 1, further comprising a grip being coupled to said handle, said grip being centrally positioned between said first end and said second end.

4. The system according to claim 1, further comprising a pair of first couplers, each of said first couplers being coupled to said handle.

5. The system according to claim 4, further comprising a pair of braces, each of said braces having a primary end and a secondary end, each of said braces comprising a first half being slidably coupled to a second half such that each of said braces has a telescopically adjustable length, said primary end of each of said braces being coupled to an associated one of said first couplers.

6. The system according to claim 5, further comprising a second coupler being coupled to said secondary end of each of said braces such that said braces form a V, said second coupler being removably coupled to said seat post such that each of said braces extends between said seat post and said handle having said handle being retained in a substantially vertical orientation.

7. A bicycle training system comprising:
a bicycle having a rear tire and a seat post, said rear tire having an axle; and
a yoke being removably coupled to said bicycle wherein said yoke is configured to be gripped by a first user thereby facilitating the first user to stabilize said bicycle when a second user is learning to ride said bicycle, said yoke comprising:
a handle having a first end and a second end, said handle being curved within a plane such that said handle is planar and said first end is spaced from said second end, each of said first end and said second end being coupled to said axle on said bicycle having said handle extending upwardly from said rear tire such that said handle is coplanar with an axis of rotation of said rear tire whereby said handle is configured to be grasped in alignment with the axis of rotation of said rear tire,
a grip being coupled to said handle, said grip being centrally positioned between said first end and said second end,
a pair of first couplers, each of said first couplers being coupled to said handle,
a pair of braces, each of said braces having a primary end and a secondary end, each of said braces comprising a first half being slidably coupled to a second half such that each of said braces has a telescopically adjustable length, said primary end of each of said braces being coupled to an associated one of said first couplers, and
a second coupler being coupled to said secondary end of each of said braces such that said braces form a V, said second coupler being removably coupled to said seat post such that each of said braces extends between said seat post and said handle having said handle being retained in a substantially vertical orientation.
